(19) United States
(12) Patent Application Publication
(10) Pub. No.: US 2009/0319298 A1
(43) Pub. Date: Dec. 24, 2009

(54) PATIENT STATUS AND HEALTHCARE INFORMATION COMMUNICATION SYSTEM AND METHOD

(76) Inventors: Sanford B. Weiss, Los Angeles, CA (US); Ashok Dave, Sherman Oaks, CA (US)

Correspondence Address: STETINA BRUNDA GARRED & BRUCKER, 75 ENTERPRISE, SUITE 250, ALISO VIEJO, CA, 92656, US

(21) Appl. No.: 12/142,165

(22) Filed: Jun. 19, 2008

(51) Int. Cl. G06Q 50/00; G06Q 10/00; G06F 17/30

(52) U.S. Cl. 705/3; 707/104.1; 707/E17.005

(57) ABSTRACT

An automated method for communicating patient status updates. The method includes registering a user. The registered user is associated with a patient file on a patient database. The patient file is representative of the patient for which the user will be receiving automated patient status updates. Patient status updates are received on the patient database via direct data entry or over a network. The patient file corresponding to the admitted patient is identified and configured to receive patient status updates for storage thereon. The patient status updates received on the patient file are formatted to conform to communication preferences established on the patient file. The method continues with the transmission of the formatted patient status updates over a network to the user communication device. A user receiving the patient status updates on the user communication device may avoid waiting at the healthcare facility for updates while being informed of any status changes in real-time.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field of the Invention

The present invention relates generally to a patient status and healthcare information communication system and, more particularly, to technology for facilitating automatic patient status updates and providing healthcare information upon request by a user via a user communication device.

2. Description of the Related Art

Healthcare professions including physicians, nurses, assistants and support staff associated with hospitals and healthcare facilities are required to maintain and update patient information, provide patient care, and assist in the treatment of patients. The healthcare professionals report the patient status to family members or friends of the admitted patient. To receive the patient status updates corresponding to the patient treatment, family and friends must wait in designated waiting areas within the hospital or healthcare facility. The designated waiting areas may be crowded and uncomfortable. Additionally, the waiting areas are staffed by a healthcare professional that may not be able to provide patient status updates to those waiting for the patient. Furthermore, the sheer quantity of those waiting may serve as a distraction to the healthcare professionals and possibly cause delays. Delays may also be caused by continuous questioning from those in the waiting rooms anxious to receive information regarding the status of a particular patient. In many situations, healthcare professionals often inform those waiting for a patient to check back at a later time on the progress and the outcome of the treatments or surgical procedures for a patient status update. The family member or friend may not know how long to wait and they are hesitant to leave for fear of missing a patient status update from the healthcare professional. In some cases, due to personnel shortages or a busy work environment, persons waiting for news concerning the patient are unable to ask a healthcare professional for information. These situations cause a high level of anxiety, further adding to the person's already heightened discomfort due to their loved one's hospitalization. Even when someone is accessible to provide patient status updates, language barriers prevent the information from being communicated to those waiting for the patient and further adding to the frustration generated in the designated waiting areas. Often, these tasks have to be performed even though there are personnel shortages.

Further, as medical technology continues to develop to provide treatment for a greater number of medical conditions, the volume of information that is maintained for each patient continues to grow rapidly. As a result, stress on the healthcare professional staff has increased and the quantity of information processed is continuously increasing. It may be problematic to the extent an emergency room physician is unable to get in contact with a patient's primary care physician and/or family members/guardians/individuals possessing powers of attorney to make medical decisions on behalf of the patient. Along these lines, it is typically necessary for the emergency room physician to know of any pre-existing medical conditions, medications the patient may be taking, and other information regarding the patient, such as blood type, allergies, and the like. Indeed, such situation occurs with great frequency for patients residing in nursing homes, hospitals, and healthcare facilities where more immediate and comprehensive medical care can be rendered.

The quantity of information concerning a patient, a relative of the patient, and a healthcare professional may range substantially. The information may include: pre-admission requirements, hospital access, parking information, facility entry guidelines, required paperwork (e.g., medical wills and emergency contacts), discharge protocols, contact information and medications, demographics, planned procedure(s), physicians' information, patient contact information, medical records, lab results, radiology images, discharge medications, allergies, and discharge information. Additionally, visitors of the health care facility often request information for facilitating a future visit or admission by the patient. Information may include hotel listings, restaurant listings, shopping centers, and other nearby attractions. Typically, the healthcare professional staff members need to know the patient's name and address, as well as any special dietary, environmental or physical space requirements of the patient. The attending physician may want to compare particular test results with the results of newer tests to see how the patient's condition has progressed. In addition, if any medication has been prescribed, the physician or nursing staff may want to know the identity of the medication, when the last dose was taken and how the patient has complied with the dosage schedule.

Current systems utilized to manage such information include the manual writing and processing of the information. Electronic systems utilized to process and store the information involve multiple computers, each configured to process portions of the vast amount of information. To obtain all the information in one place the information stored in each computer system must be manually combined. Furthermore, such electronic systems do not provide visual displays of text at stations provided in the patient's room, at the nurse control station or at stations provided in areas of the healthcare facility frequently occupied by the healthcare professionals.

One type of system utilized to locate personnel within a hospital or other health care facility relies on a paging system, to facilitate such communications while a person is not within the healthcare facility. Healthcare professionals rely on mobile phones and/or pagers to maintain communication with hospitals, nursing homes/assisted living facilities and the like. However, the use of such tools in combination with existing communication systems do not necessarily provide for the exchange of significant amounts of data as may be required. Moreover, such communication systems are inoperative to provide a comprehensive network by which information can be exchanged not only between physicians, but also between other key entities involved in the administration of healthcare, such as information from labs regarding laboratory tests, nurses and other personnel responsible for overseeing the administration of healthcare, and perhaps most importantly, family members/guardians of the patient.

The available communication systems do not appear to provide a system for communicating automatic patient status updates and healthcare information associated with the patient and the healthcare facility. Additionally, the above described systems do not provide a systematic and simple method for providing the patient, the patient's family and friends, or a healthcare professional the ability to access important information for facilitating the visit at the healthcare facility. Accordingly, a need exists for a patient status and healthcare information communication system capable of performing tasks such as providing text updates to the family of the patient via mobile phones and/or browser access directly from the hospital's treatment areas (e.g., operating room or recovery rooms) on periodic intervals and is capable of capturing key contact information and specific discharge instructions to facilitate the patient's post hospitalization recovery. The patient status and healthcare information communication system facilitates population of its patient specific database for information relating to pre-admission and post discharge protocols and tips.

There does not exist a systematic and simple method of providing the patient and the family with a short list of key information pointers such as: pre-admission requirements, hospital access, parking, facility entry information, required paperwork (e.g., medical wills and emergency contacts), discharge protocols, key contacts and medications.

Accordingly, there exists a need in the art for a patient status and healthcare information communication system. This need is addressed by the present invention, as will be described in more detail below.

### BRIEF SUMMARY

The present invention specifically addresses and alleviates the above-identified deficiencies in the art. In this regard, the present invention is directed to an automated method for communicating patient status updates. The method includes registering a user who will be receiving the automated patient status updates. The registered user is associated with a patient file on a patient database, wherein the patient file is representative of the patient for which the user will be receiving automated patient status updates. The method continues by receiving patient status updates on the patient database. The patient status updates may be received on the patient database via a direct data entry or over a network. The method also contemplates identifying the patient file corresponding to the received patient status updates on the patient database. In other words, the patient status updates are matched to the appropriate patient file. The patient status updates received on the patient file are formatted to conform to communication preferences established on the patient file. The method continues with the transmission of the formatted patient status updates over a network to the user communication device.

An aspect of the present invention contemplates the patient database receiving patient status updates inputted directly by a healthcare professional. Additionally, patient status updates may be received on the patient database via a monitoring device coupled to a patient. The monitoring device is in communication with the patient database and may provide the patient status updates to the patient database continuously or periodically. It is contemplated that the monitoring device may be any well known medical equipment used to monitor the patient's status.

In one embodiment, the patient file stored on the patient database includes the patient's medical records. An aspect of the present invention contemplates the patient file receiving data from the user communication device. In other words, information stored within the patient file may be updated by the user using the user communication device. The user may include any person from the group consisting of a healthcare professional, a relative of the patient, a friend of the patient, a legal guardian of the patient, and the patient. It is also contemplated that the user communication device is a wireless device in communication with a server through a wireless network. The user communication device can be a mobile phone.

In yet another embodiment, a method for communicating information associated with a healthcare facility responsive to a user request for information is provided. The user request for information may be communicated via a user communication device. The method includes receiving a user request for information on a host server. The host server includes a software application for processing the user request. The software application determines the appropriate database from a plurality of databases based upon the processing of the user request. The selected database is accessed in order to find data responsive to the user request for information. After finding the data responsive to the user request, the data is formatted in accordance with communication preferences established on the user communication device. Subsequently, the formatted data responsive to the user request is transmitted to the user communication device over a network. The plurality of databases for which data responsive to the user request may be found, include, the patient database, a healthcare facility main information system database, and a healthcare facility website. The healthcare facility main information system database may consist of a hospital information system which includes information associated with admissions, discharge, transfer, emergency room, and various ancillary departments including but not limited to radiology, labs, therapy, pharmacy, cardiology, surgery, recovery, critical care, transportation, medical records, dietary, business office.

In another embodiment, a patient status communication system is provided. The communication system includes a server and a patient database that are in communication with one another. The communication system also includes a software application that performs a method for providing patient status notifications/updates. The software application is processed on the server. The method the software application performs includes registering a user. The registered user is then associated with a patient file on the patient database. The appropriate patient file is identified. The appropriate patient file includes the patient file representative of the patient for which the patient status updates are being received on the patient database. Upon identifying the appropriate patient file, the patient status updates stored thereon are formatted to conform to communication preferences established on the patient file. The method may conclude with the transmission of the formatted patient status updates. The transmission may be accomplished over a network to the user communication device.

An aspect of the present invention contemplates the patient database being hosted on the server. The server may receive a request for information from the user communication device. The software application has the ability to access data responsive to the request for information from the user communication device. The software application is configured to access the patient database, a healthcare facility main information system database, a healthcare facility admission system database, and a healthcare facility website. The communication system may also receive patient status updates on the patient database via direct data entry from a healthcare profession. Alternatively, the communication system may receive patient status updates on the patient database via a user communication device registered to a healthcare professional. Patient status updates may also be received on the patient database via a monitoring device. The monitoring device is coupled to the patient and communicates the patient status to the server.

The method for communicating patient status updates to a user having a communication device may also be adaptable for application in the hospitality industry. For example, the method is adaptable for use associated with guests at a hotel. In this regard, a guest at a hotel may use a communication device to access various activities. The activities may include restaurants within the hotel, a listing of restaurants in close proximity to the hotel, gym, spa, and other amenities. Information associated with parking, check-in and check-out procedures, room service, cleaning and other services are accessible via the user communication device. Furthermore, upon the guest/user registering with the hotel, the guest/user may elect to receive automatic updates and suggestions for activities located at the hotel and in close proximity to the hotel. Furthermore, based on the guest preferences the information may be transmitted to the communication device in a language preferred by the guest. In this regard, the guest may receive automatic updates in Spanish if Spanish is the language selected by the guest.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a block diagram of a patient status and healthcare communication system for providing patient status updates over various networks to a plurality of user communication devices in accordance with an embodiment of the present invention;

FIG. 2 illustrates various patient status and healthcare information that can be provided in accordance with an embodiment of the present invention;

FIG. 3 illustrates a process for automatically transmitting patient status updates to a user in accordance with an embodiment of the present invention; and

FIG. 4 illustrates a process for transmitting patient status updates or healthcare information in response to a user request.

### DETAILED DESCRIPTION

The detailed description set forth below is intended as a description of an embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Patient status and health care information communication system and related methods can be provided for automatically updating patient status to remote user communication devices, such as wireless devices, over one or more networks. The communication system may also receive requests for information from a user communication device. The requests may be in response to an automated patient status update. Alternatively, the request for information may be associated with the healthcare facility independent of the admitted patient. This information may include, for example, hotel listings near the facility, restaurant information, hospital visiting hours, parking information, and other general information for facilitating access to the healthcare facility and the surrounding environment. One aspect of the present invention contemplates implementing a revenue generating model associated with the patient status and health care information communication system. In this regard, a fee may be charged for inclusion into a listing of hotels, restaurants, or other businesses located near the healthcare facility. For example, if a person visiting the health care facility inquires about nearby florists using the communication system, those florists that are listed in response to the visitor's request are charged a fee. The fee generating aspect may be applicable to a plurality of businesses and services.

Various embodiments of the communication system can provide support for selectively transmitting voice-based messages, text-based messages, video-based images and/or other customized messages to wireless devices and/or devices in communication with the communication system through landlines. Further embodiments can provide support for browser-based access to the communication system through the Internet and/or other computer networks. Although the communication system and related methods are chiefly described herein in relation to the healthcare industry, it will be appreciated that the various embodiments of the communication system and related methods can be implemented to support other types of data, where appropriate. Along these lines, it is expressly contemplated that the communication system and related methods may be operative to simply serve as a direct communications link between individuals and entities involved in the administration of healthcare to a particular patient. For example, the communication system and methods may be implemented for a care giver network extending to fire department and ambulance services. The communication system and related methods may also be applicable to other industries such as the hospitality industry.

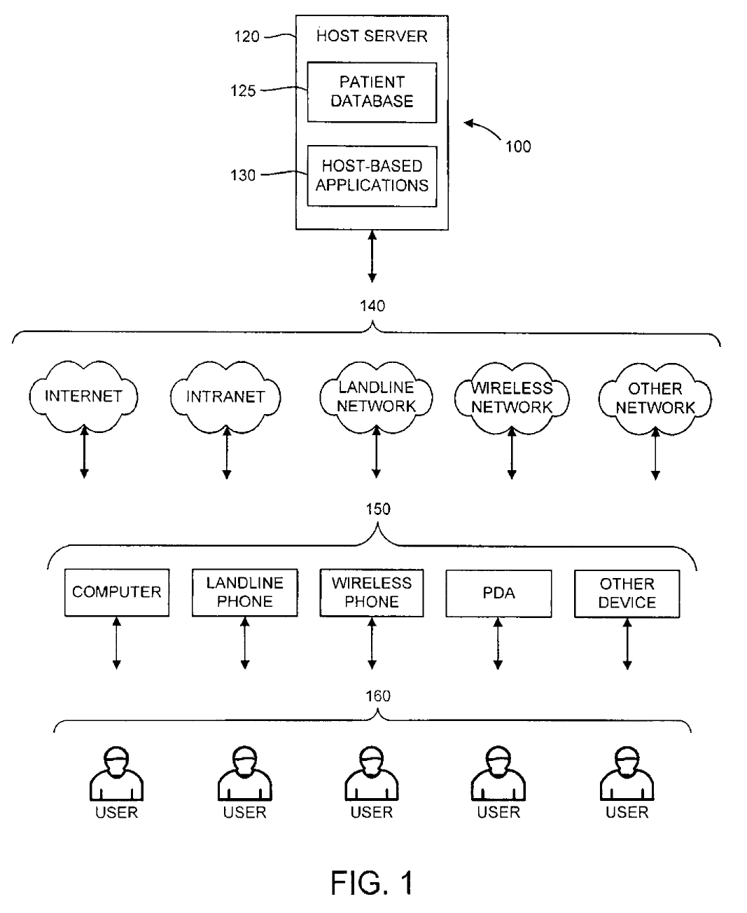

Referring now to the figures of the present disclosure, FIG. 1 illustrates a block diagram of a patient status and healthcare information communication system 100 for providing patient status updates and/or general healthcare information over various networks 140 to a plurality of user communication devices 150 in accordance with an embodiment of the present invention. The communication system 100 may be configured to automatically provide patient status updates to user communication devices 150. The communication system 100 may also receive request for general information associated with a healthcare facility. Upon receiving the request, the communication system 100 may access a database to generate a response to transmit to the user communication device 150. A host server 120 can be provided for facilitating the communication of patient status updates, medical data, and healthcare information as further described herein. In one embodiment, the host server 120 can be implemented as a server supporting Microsoft Internet Information Services (IIS) 7.0 and Microsoft .Net v 3.5.

As illustrated, the host server 120 can be implemented to access data from a plurality of databases. If the host server 120 receives a request for patient status information from the user communication device 150, the host server 120 may access a patient database 125. Assuming the patient database 125 includes information associated with the patient status. The host server 120 may also access a healthcare facility admission system database, a healthcare facility main information system database, or a website associated with the healthcare facility. Thus, if a request for information is made by the user communication device 150 for information associated with the healthcare facility or surrounding area, the databases may be accessed for data responsive to the request. It will be appreciated that the patient database 125 can alternatively be implemented separate from, and in communication with, the host server 120. In one embodiment, the patient database 125 can be implemented on a server compatible with an MS/SQL Server.

The patient database 125 of the communication system 100 is a patient specific database. The patient database 125 may include a patient file corresponding to each patient admitted for treatment with the healthcare facility. The patient file may include a plurality of information associated with the admitted patient. The information may include contact information, address, physician information, medical conditions, and various data associated with the patient that may facilitate treatment. The patient file may also include information such as a preferred language of communication. Thus, a physician reading the patient file would be aware that English may not be the language of choice to communicate with the patient. Other communication preferences are contemplated. These preferences may include who the patient provides permission to visit the patient at the healthcare facility. The communication preferences on the patient file facilitate communication with the patient, relatives of the patient, a legal guardian, or the patient's physician.

The patient database 125 may include patient specific information such as demographics, planned patient procedure(s), patient physician information, patient contact information, pre-admission requirements, and hospital access protocols. The patient specific information stored on the patient database 125 may be extracted from the healthcare facility's admitting system. The host server 120 may be implemented to access the information on the healthcare facility's admitting system and transfer the information to the patient file within the patient database 125. The host server 120 may also receive information via direct data entry. For example, if a healthcare professional employed by the healthcare facility is updating the patient profile with a diagnosed condition, this information may be directly inputted into the hosted server 120. The hosted server 120 may then store the information within the appropriate profile of the patient database 125. The host server 120 may also receive patient status updates from medical equipment used to monitor the patient. The medical equipment is coupled to the patient and used to monitor the status of the patient. The medical monitoring equipment may be configured to continuously or periodically update the host server 120 with patient status updates. The information may be communicated to the host server 120 over a network 140. The patient database 125 is also configured to import a summary of patient medical records (e.g., lab results, radiology images, discharge medications, allergies, and discharge summaries).

A personal healthcare record module may also be associated with each patient file within the patient database 125. The personal healthcare record module allows the patient to enter his/her medical information, such as results from other healthcare facilities/hospitals. This allows the patient to build and maintain his/her own specific critical medical care record to be stored on the patient database 125. The patient may directly update demographics, patient contact information, and insurance information into the patient database 125. It is also contemplated that the host server 120 is in communication with the healthcare facility's main information system in order to update any information received on the patient database 125 via patient or physician input. The communication systems 100 ability to update patient database 125 information facilitates future visits or admission by the patient. The personal healthcare record module is configured to receive information from the user communication device 150. Therefore, the patient may provide information such as new contact information to be stored in the patient file via the user communication device 150.

A user 160 of the communication system 100 may automatically receive patient status updates or request information associated with the healthcare facility. The user 160 may include a family or friend of the patient, a legal guardian, a physician treating the patient, and/or the patient. The user 160 receives information from the communication system 100 transmitted over at least one network 140 to the user's 160 communication device 150. Additionally, the user 160 may request information from the communication system 100 via the communication device 150. The request may be transmitted over the network 140 to the host server 120. If the user 160 is a relative of the patient, it is contemplated that the user 160 will receive automatic patient status updates from the communication system 100 to the user communication device 150.

One or more host-based applications 130 can be provided on the host server 120 for facilitating the processing features of the communication system 100. In various embodiments, applications 130 can be implemented as compiled code running on various web application frameworks and/or SSL encryption certificate services can also be supported. Connection specifications can be embedded within the application code and associated configuration files. Host-based applications 130 can be implemented to utilize IIS 7.0 SSL features for supporting secured access. Accordingly, any user communication devices 150 that are not supporting secure sockets layer (SSL) at runtime (for example, web browsers running on computers or PDAs that do not comply and/or allow SSL web access) can be denied access to the communication system 100. The host based applications 130 are configured to assess patient status updates received on the host server 120 and information requested by a user 160 via the user communication device. When the host server 120 receives patient status updates, the host based application 130 may direct the information into the patient database 125. Additionally, the host based application 130 may be utilized to format the patient status updates to conform to communication preferences established in the patient file. Further, the host base application 130 is utilized to process a request for information to determine which database to access to find a response to the user 160 request for information. For example, if the user 160 is inquiring about a nearby hotel, the host based application 130 would select the healthcare facility's main information system database to seek data responsive to this request rather than searching within the patient database 125.

Host server 120 can be implemented to communicate with one or more networks 140. As set forth in FIG. 1, a plurality of different networks can be supported, including but not limited to: the Internet, intranets, landline networks, wireless networks, and/or other networks known in the art.

A plurality of user communication devices 150 can be provided in communication with the networks 140 supported by the communication system 100. As illustrated, user communication devices 150 can include, but need not be limited to: computers, landline telephones, wireless telephones, personal digital assistants (PDAs), and/or other mobile or non-mobile user devices known in the art for providing electronic communication. It will be appreciated that, where applicable, any of the user communication devices 150 can communicate over one or more of the networks 140 if the user communication device 150 supports compatibility with the network 140. In one embodiment, user communication devices 150 that are PDAs can be provided with a web browser compatible with SSL.

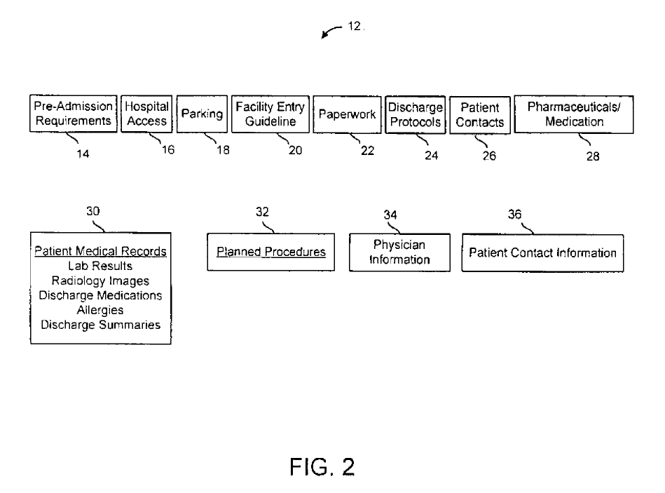

Referring now to FIG. 2, there is shown patient status and healthcare information 12 that may be sent or received by the communication system 100. The patient status and healthcare information 12 may be stored on the patient database 125, the healthcare facility admissions system, the healthcare facility main information system, or the healthcare facility website. As illustrated, such information may include, but need not be limited to pre-admission requirements 14, hospital access 16, parking information 18, facility entry guidelines 20, paperwork (e.g., medical wills and emergency contacts) 22, discharge protocols 24, patient contacts 26, and pharmaceuticals/medication 28. Other information may include patient medical records 30 (e.g., lab results, radiology images, allergies, discharge medications, and discharge summaries), planned procedures 32, physician information 34, and patient contact information 36.

As further described herein, the various patient status and healthcare information illustrated in FIG. 2 can be provided in accordance with data formats compatible with one or more of the user communication devices 150. For example, the patient status and healthcare information 12 can be formatted in a data format selected from the group consisting of: a digital image, an audio file, a text document, and/or other appropriate data formats.

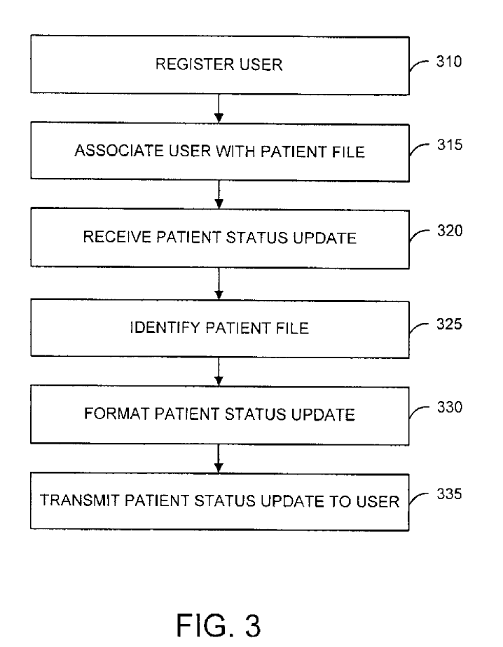

FIG. 3 illustrates a process for an automated method of communicating patient status updates to the user 160 via the user's communication device 150 in accordance with an embodiment of the present invention.

At step 310, the user 160 is registered with the patient database 125. Registering the user 160 can be implemented by directly entering data into the host server 120 or the patient database 125. The registration process prevents unauthorized users from receiving patient status updates. Registering the user 160 may also establish the access to information based upon different security protocols. For example, if the user 160 is the patient, it is understood that the user 160 will have access to the entire patient's file stored on the patient database 125. Additionally, the user 160 may have access to the patient database 125 via the user communication device 150 to update personal information or medical records associated with the patient file. However, if the user 160 is a relative of the patient, access to the patient file on the patient database 125 may be restricted or limited. The registration process may further serve to differentiate a plurality of users associated with a patient file. Thus, it is contemplated that each user 160 may have different access protocols.

At step 315, the user 160 is associated with an admitted patient. The user 160 is associated with a patient file in order to receive patient status updates corresponding to a particular patient. In this regard, the patient file represents the patient. When patient status updates are uploaded to the patient file, the user's 160 associated with the patient file may be eligible to receive the patient status update. However, the patient file may include communication preferences, security settings, and other precautions to limit patient status updates to the registered users 160. For example, communication preferences may include a language the user 160 prefers receiving patient status updates to the user communication device 150. In this context, the system and method contemplate multiple language communication capability. The user 160 may simply select the language in which the patient status updates are to be received on the communication device 150. The communication preferences may also include various options such as limiting the quantity of patient status updates, the type of patient status update, and timing. For example, the user 160 may request to only be notified when the patient has finished treatment at the healthcare facility. The communication preferences may be determined through user 160 responses to a questionnaire associated with various communication preferences. It is also contemplated that the user 160 may set the communication preferences via the user communication device 150.

The communication preferences may also be set by the patient and included in the patient file. For example, the patient may request that only family members listed under the communication preferences within the patient file may receive patient status updates. In this scenario, any user 160 registering with the patient database 125 that does not correspond to the designated family member will not be able to receive patient status updates. In one embodiment it is contemplated that the patient is the user 160 and may configure the communication preferences via the user communication device 150. Thus, the communication preferences listed in the patient file are not rigid standards but may be flexible based upon the patient's preferences. If the user 160 is the patient's family member or a friend, the access the user 160 may have is dependent upon the patient's preferences as represented in the patient file. If the user 160 is a treating physician or other healthcare professional, the access to the patient profile may be limited.

At step 320, the patient database 125 receives patient status update. The patient status update is detectable by one or more of the host-based applications 130 running on the host server 120. For example, the host-based applications 130 may detect when the patient file on the patient database 125 receives patient status updates associated with patient medical records, planned procedures, or medications the patient may require. In the case of medical data, a host-based application 130 may detect the presence of new and/or updated medical data associated with the patient database 125, whether stored therein or otherwise. It will be appreciated that such new/updated medical data can be received by host server 120 through communication with one or more of networks 140, and passed to the patient database 125 as provided in step 320.

In one embodiment, patient status updates are received on the host server 120 when inputted into the communication system 100 by the healthcare professional. The patient status update may be inputted via the user communication device 150 or direct data entry. In the past, a doctor or physician would enter results or have an assistant enter results from an examination, procedure, or treatment. Additionally, the physician may inform family members waiting for the patient as to the status and results. However, if a family member is registered as a user 160, patient status updates can be received on the user communication device 150. Therefore, the physician may not be required to explain the results and thus spend his/her time more efficiently. Additionally, the user 160 is free to leave the waiting room without the risk of missing patient status updates. Alternatively, the patient status updates are transmitted to the host server 120 over the networks 140 via patient monitoring devices. In this respect, the patient monitoring devices that are hooked up to the patient are in communication with the communication system 100. Thus, the hosted server 120 is configured to receive continuous or periodic updates from the patient monitoring devices.

At step 325, the patient file corresponding to the admitted patient is identified. Upon receiving patient status updates on the patient database 125, the patient status updates must match the patient file representative of the patient for which the status updates are associated with. Once the patient file is identified, the patient status updates may be stored within the patient file.

Following step 325, at step 330, the patient status update stored on the patient file must be conformed to the communication preferences prior to transmittal to the users 160. If one user 160 sets their language preference to a foreign language, the patient status update is translated prior to transmitting the update to that particular user 160. Another user 160 may have set the communication preferences to receive patient status updates only to notify the user 160 when the procedure is completed. Thus, any patient status updates not corresponding to the procedure being completed will not be delivered or transmitted to the user 160. The host-based application 130 may process the communication preferences to format the patient status update for conformance to each user 160 accordingly. At step 335, the formatted patient status updates are transmitted over a network 140 the user communication device 150. It is contemplated that the user 160 may receive the formatted patient status updates on a mobile phone via text message. In this regard, the user 160 is not confined to the waiting room to receive patient status updates.

At step 335, the patient status update can be broadcasted across one or more of the networks 140. It will be appreciated that in order to support a plurality of different data formats and communications standards supported and/or required by various networks 140, the patient status update can be converted by one or more of the host-based applications 130 into an appropriately-formatted communication prior to the transmittal of step 335. Thus, family members of the patient are relieved from having to wait in a crowded waiting room not knowing when they will receive an update on their loved one's condition, treatment, or procedure. The present invention allows the family member to register with the communication system 100 to receive patient status updates. This provides the family member with freedom to leave the healthcare facility without worrying what time to return or having to worry that an update from a healthcare professional will be missed. The family member simply receives the patient status updates via text message or other format over the network 140 the communication device 150. Furthermore, the family member may receive healthcare information such as post-hospitalization procedures to facilitate care for the patient after leaving the hospital or healthcare facility.

Following the transmission of the patient status update, it can be received by one or more of the user communication devices 150 (step 335) through one or more of the networks 140. It will be appreciated that various user communication devices 150 may support a variety of features which may be employed to notify the user 160 that an alert notification has been received. For example, the user communication device 150 may exhibit an audible sound, vibration, visual display, and/or another appropriate indication to signify that a patient status update has been received.

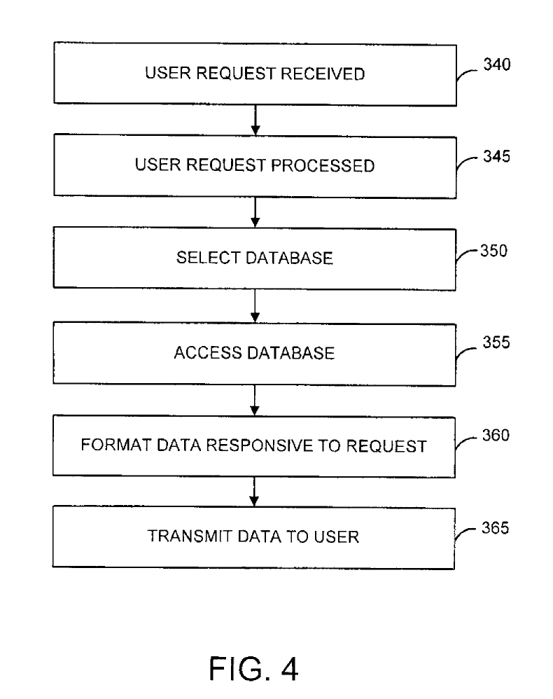

Referring now to FIG. 4, a process is provided wherein the user 160 may request patient status updates or healthcare information. Step 340 contemplates receiving a user request for information on a host server 120. The user request is passed through the network 140. The user request is passed from the user communication device 150 through an appropriate one or more of networks 140 compatible with the user communication device 150. The user 160 request for information may range from a request for patient status updates to parking information at the healthcare facility. The information available facilitates the dissemination of information associated with the healthcare facility. For example, if the user 160 is a relative of the patient and just received a patient status update on the user's communication device 150 that there has been a delay associated with the patient's surgical procedure and the procedure is not expected to start until the following day. The user 160 may want to obtain a listing of hotels near the healthcare facility. The user 160 may then request a listing of hotels via the user communication device 150. If the user 160 is the patient, the patient may request information from the communication system 100 corresponding to discharge protocols. The information requested from the communication system 100 may include by way of example pre-admission requirements 14, hospital access 16, parking information 18, facility entry guideline 20, required paperwork 22, discharge protocols 24, patient contact information 26, medication 28, patient medical records 30, planned procedure(s) 32, physician information 34, and patient contact information 36.

At step 345, the user request for information is processed. It is contemplated that the quantity of information available may not be located at a universal database. For example, informing concerning the patient is located on the patient database 125, information concerning the healthcare facility may be located on a main information system database, and information associated with the surrounding area may be listed on a website associated with the healthcare facility. Based upon the user request, the host based application 130 may determine which database will contain information responsive to the user request. Step 350 contemplates selecting the appropriate database. If the user 160 would like patient status updates, the appropriate database selected by the host based application 130 should be the patient database 125. Following step 350, the appropriate database is accessed for data responsive to the user request (step 355). During step 355, the host-based application 130 can dynamically extract the particular data sought by the user request from the appropriate database.

The data responsive to the user request for information may also be formatted in accordance with the communication preferences prior to transmittal to the user 160 (step 360). The communication preferences may be set by the user 160 via the user communication device 150 and stored on the host server 120. For the scenario where the user 160 requests patient status updates, communication preferences may also be set by the patient. Thus, the patient may regulate the patient status updates transmitted to the users 160. The host-based application 130 may process the communication preferences to format the data. At step 365, the formatted data is transmitted over a network 140 the user communication device 150. It is contemplated that the user 160 may receive the formatted data responsive to the user request on a mobile phone via text message. The communication system 100 sends the data responsive to the user 160 request over the network 140 as provided in step 365.

It is contemplated that the user request passed through the network (step 340) may be a response to the patient status update received on the user communication device 150 subsequent to step 335. An aspect of the present invention contemplates the user request (step 340) being sent from the same user communication device 150 that received the patient status update. However, it is also contemplated that one or more alternative user communication devices 150 may be used to send the user request and support the further interaction between the user 160 and the communication system 100. For example, if a user 160 requests a patient status update on a particular wireless phone, it may be desirable for the user 160 to access the patient status update through a PDA device which may exhibit a larger screen, thereby permitting the user 160 to more easily view the patient status update to be accessed from the communication system 100. Similarly, the user may desire to receive notifications wirelessly (i.e. through a wireless user communication device 160), but access the patient status updates through a landline-based user communication device 160.

Advantageously, in some embodiments, the data accessed on user communication device 150 can be stored in only volatile memory of the user communication device 150, and only while the user communication device 150 maintains a communication link with system 100. As such, it will be appreciated that by not storing the data in semi-permanent and/or permanent memory of the user communication device 150, the likelihood of inadvertent disclosure of private/personal medical data can be reduced.

The communication system 100 can also be implemented to limit user 160 interaction with the communication system 100 to pre-selected time intervals (for example, 5 minute sessions or 10 minute sessions). Upon the expiration of a time interval, the user 160 may be required to re-login in order to further access features of the system 100.

It will be appreciated that through the execution of the process of FIG. 3, real-time patient status updates can be automatically provided to users 160 of various user communication devices 150. Users 160 can then respond to such status updates and access data through one or more user communication devices 150 over one or more networks 140 compatible with the user communication devices 150. As a result, patient's, family members, medical professionals and/or other users 160 can receive timely updates of meaningfully significant amounts of medical data independent of location or time of day.

Where applicable, the present invention can be implemented using hardware, software, and/or combinations of hardware and software. Also where applicable, the various hardware components and/or software components set forth herein can be combined into composite components comprising software, hardware, and/or both without departing from the spirit of the present invention. Where applicable, the various hardware components and/or software components set forth herein can be dissected into sub-components comprising software, hardware, and/or both without departing from the spirit of the present invention. In addition, where applicable, it is contemplated that software components can be implemented as hardware components, and vice-versa.

Software in accordance with the present invention, such as program code and/or data, can be stored on one or more computer readable mediums. It is also contemplated that software identified herein can be implemented using one or more general purpose computers, specific purpose computers, and/or computer systems, networked and/or otherwise.

Where applicable, the ordering of various steps described herein can be changed, combined into composite steps, and/or dissected into sub-steps to provide the functionality described herein.

It will be appreciated that the patient status and healthcare information communication system and method is applicable to the hospitality industry. The system and method may be applicable to restaurants, hotels, and theme parks by way of example only and not of limitation. With respect to hotels, the user 160 may register with a hotel similar in manner in which the user 160 may register with a healthcare facility. The user 160 may select to receive automatic updates on the user's communication device 150. The information to be received by the user communication device 150 and updated automatically may include available activities associated with the hotel, locations and timing for certain events. The user 160 may also request information from a database regarding things to do, see, or visit that is in close proximity to the hotel. These activities may include restaurants, shopping malls, specialty stores, theme parks, shows, theatres, and the like. Additionally, the user 160 may set his or her preferences to receive automatic updates in a preferred format. For example, if the user 160 prefers receiving information in French, an option may be selected such that all communications transmitted to the user's communication device 160 is in French. Furthermore, the database that may be associated with the hotel may be configured to provide automatic updates to users 160 about other registered users if permission is granted by another user 160. In this regard, a user 160 may notify the database via the user communication device 150 that the user 160 is leaving the hotel. Another user 160 may receive an automatic message informing that a particular user 160 has left or is leaving. Alternatively, a user 160 may be notified when another user 160 has returned to the hotel.

In one embodiment, the method and system is applicable to visitors of theme parks. Upon registering with a database associated with a particular theme park, the user 160 may choose to receive automatic updates. This may include show times, restaurant listings and locations, attractions that are open or closed, requirements for particular attractions, line queue times, bathroom locations, first aid, and the like. Preferences may be transmitted by the user 160 to the database. For example, a request for an automatic notification to be transmitted to the user communication device 150 when a rides queue time is less than 30 minutes may be delivered. Various other preferences are contemplated which will facilitate the user's 160 visit. Additionally, it is well known that tourists from a plurality of countries visit theme parks and hotels. These tourists speak many different languages. Thus, a system and method that may communicate information to the user 160 via their communication device 150 in a preferred language will enhance their experience and reduce the reliance of the user's on employees where the system and method is adapted for use.

Furthermore, the various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention.

What is claimed is:

1. A patient status communication system comprising:
a server;
a patient database in communication with the server; and
a software application for performing a method for providing patient status updates, the software application running on the server, the method comprising:
registering a user,
associating the user with a patient file on the patient database,
receiving patient status updates on the patient database,
identifying the patient file corresponding to the received patient status updates for storage on the patient file,
formatting patient status updates stored on the patient file to conform to communication preferences established on the patient file, and
transmitting the formatted patient status updates over a network to the user communication device.

2. The system of claim 1, wherein the patient database is hosted on the server.

3. The system of claim 1, wherein the server receives a request for information from the user communication device.

4. The system of claim 3, wherein the software application accesses data responsive to the request for information from the user communication device from the group consisting of:
the patient database;
a healthcare facility main information system database; and
a healthcare facility website.

5. The system of claim 1, wherein patient status updates are received on the patient database via direct data entry from a healthcare professional.

6. The system of claim 1, wherein patient status updates are received on the patient database via the user communication device registered to a healthcare professional.

7. The system of claim 1, wherein patient status updates are received on the patient database via a monitoring device coupled to a patient, the monitoring device being in electrical communication with the patient database.

8. The system of claim 1, wherein the patient file includes the patient's medical records.

9. The system of claim 8, wherein the patient file receives data from the user communication device.

10. The system of claim 1, wherein the user is from the group consisting of:
a healthcare professional;
a relative of the patient;
a friend of the patient;
a legal guardian of the patient; and
the patient.

11. The system of claim 1, wherein the network is a wireless network, the communication device is a wireless device in communication with the system through the wireless network.

12. An automated method for communicating patient status updates, the method comprising:
registering a user;
associating the user with a patient file on a patient database;
receiving patient status updates on the patient database;
identifying the patient file corresponding to the received patient status updates for storage on the patient file; and
formatting patient status updates stored on the patient file to conform to communication preferences established on the patient file; and
transmitting the formatted patient status updates over a network to the user communication device.

13. The method of claim 12, wherein patient status updates are received on the patient database via direct data entry by a healthcare professional.

14. The method of claim 12, wherein patient status updates are received on the patient database via a monitoring device coupled to a patient, the monitoring device being in electrical communication with the patient database.

15. The method of claim 12, wherein the patient file includes the patient's medical records.

16. The method of claim 15, wherein the patient file receives data from the user communication device.

17. The method of claim 12, wherein the user is from the group consisting of:
a healthcare professional;
a relative of the patient;
a friend of the patient;
a legal guardian of the patient; and
the patient.

18. The method of claim 12, wherein the network is a wireless network, the communication device is a wireless device in communication with a server through the wireless network.

19. The method of claim 12, wherein the patient status updates are translated to a language selected by the user.

20. A method for communicating information associated with a healthcare facility responsive to a user request for information via a user communication device, the method comprising:
receiving a user request for information on a host server;
processing the user request using a software application on the host server;
selecting a database from a plurality of databases based upon the user request processed by the software application;
accessing the selected database for data responsive to the user request;
formatting the data responsive to the user request in accordance with communication preferences established on the user communication device; and
transmitting the formatted data responsive to the user request over a network to the user communication device.

21. The method of claim 20, wherein the database selected from the plurality of databases is selected from the group consisting of:
a patient database;
a healthcare facility main information system database;
a healthcare facility admission system database; and
a healthcare facility website.
